(19) United States
(12) Patent Application Publication
(10) Pub. No.: US 2024/0202324 A1
(43) Pub. Date: Jun. 20, 2024

(54) SENSOR DEVICE PROTECTION AGAINST ATTACK

(71) Applicant: AT&T Intellectual Property I, L.P., Atlanta, GA (US)

(72) Inventors: Joseph Soryal, Glendale, NY (US); Venson Shaw, Kirkland, WA (US)

(21) Appl. No.: 18/068,512

(22) Filed: Dec. 19, 2022

(51) Int. Cl. G06F 21/55; G01D 18/00

(52) U.S. Cl. CPC G06F 21/554; G01D 18/00; G01D 2218/10; G06F 2221/034

(57) ABSTRACT

A processing system including at least one processor may monitoring a performance of at least one sensor function of the first sensor device, detect an anomaly in the performance of the at least one sensor function, send a request to at least one neighboring sensor device to host the at least one sensor function of the first sensor device, receive an acceptance to the request from the at least one neighboring sensor device to host the at least one sensor function of the first sensor device and transfer a software code of the at least one sensor function to the at least one neighboring sensor device.

The present disclosure relates generally to network-connected sensor devices, and more particularly to methods, computer-readable media, and apparatuses for protecting sensor devices, e.g., Internet of Things (IoTs), from attacks, e.g., cyber attacks, denial of services (DOS) attacks, malicious hardware manipulation, physical tampering, vandalizing, and the like.

### BACKGROUND

Current trends in wireless technology are leading towards a future where virtually any object can be network enabled and Internet Protocol (IP) addressable. The pervasive presence of wireless networks, including cellular, Wi-Fi, ZigBee, satellite and Bluetooth networks, and the migration to a 128-bit IPv6-based address space provides the tools and resources for the paradigm of the Internet of Things (IoTs) to become a reality. In addition, the household use of various sensor devices is increasingly prevalent. These sensor devices may relate to biometric data, environmental data, premises monitoring, and so on.

### SUMMARY

In one example, the present disclosure describes a method, computer-readable medium, and apparatus for protecting a sensor device. For example, a processing system including at least one processor may monitor a performance of at least one sensor function of the first sensor device, detect an anomaly in the performance of the at least one sensor function, send a request to at least one neighboring sensor device to host the at least one sensor function of the first sensor device, receive an acceptance to the request from the at least one neighboring sensor device to host the at least one sensor function of the first sensor device and transfer a software code of the at least one sensor function to the at least one neighboring sensor device.

### BRIEF DESCRIPTION OF THE DRAWINGS

The teachings of the present disclosure can be readily understood by considering the following detailed description in conjunction with the accompanying drawings, in which:

FIG. 1 illustrates an example network related to the present disclosure;

FIG. 2 illustrates examples of sensor device to sensor device communications;

FIG. 3 illustrates a flowchart of an example method for protecting a sensor device; and

FIG. 4 illustrates a high level block diagram of a computing device specifically programmed to perform the steps, functions, blocks and/or operations described herein.

To facilitate understanding, identical reference numerals have been used, where possible, to designate identical elements that are common to the figures.

### DETAILED DESCRIPTION

Examples of the present disclosure provide for methods, computer-readable media, and apparatuses for protecting sensor devices, e.g., Internet of Things (IoTs), from attacks. In particular, examples of the present disclosure provide for the protection of sensor devices (also referred to herein as IoTs or IoT devices). The Internet of Things devices (IoTs) describe a network of physical electronic devices or “things” that are embedded with sensors, software, and hardware for the purpose of connecting and exchanging data with other devices and systems over a network, e.g., the Internet. These electronic devices may be incorporated into ordinary household devices (e.g., IoT-enabled kitchen appliances, IoT-enabled thermostats, IoT-enabled baby monitors, IoT-enabled security systems, and the like) to very sophisticated commercial-grade devices (e.g., connected cars, connected trains, connected buses, and the like). It is believed that the number of deployed IoTs will number in the tens of billions in the next few years.

The popularity of deploying numerous IoTs is based on the fact that such sensor devices are relatively low cost to produce and to deploy. Namely, such sensor devices have very limited capability in terms of processing power and have low power requirements. Such sensor devices often have very specific tasks to perform, e.g., reporting on a measured temperature, reporting on a measured humidity, reporting when a motion is detected, reporting when an access point is breached, reporting when an entity is detected within an image, reporting a physical location (e.g., reporting Global Positioning System (GPS) information), reporting on a measured speed, reporting on a measured acceleration, reporting on a distance traveled, reporting on measured biometric data (e.g., such as heart rate, breathing rate, blood oxygen level, blood pressure, blood sugar level, and so on) and the like. Thus, incorporating a sensor device to an unsophisticated appliance such as a refrigerator will suddenly elevate that appliance to a smart appliance.

Unfortunately, the strength of the IoT is also its weakness. Since an IoT is inexpensive, it is often deployed with limited capability to withstand sophisticated malicious attacks. For example, it may be relatively easy to compromise or hack a smart thermostat, a smart refrigerator, a smart temperature sensor, a smart monitoring camera, and the like. For example, a malicious user may alter a home thermostat setting while a family is vacationing (e.g., turning the heat off in the house during the winter thereby potentially causing water pipes to freeze), or may alter a freezer temperature setting while a family is not at home (e.g., raising the freezer temperature thereby causing frozen food to defrost). Such malicious acts may cause significant losses in time and money to the victims. Alternatively, such IoTs may simply fail due to normal usage without suffering any malicious acts having occurred, e.g., a power surge may disable or damage such IoTs.

As IoTs becoming more pervasive in our surroundings, many critical functionalities are becoming more dependent on their use. For example, if an IoT malfunctions or is compromised (physically or logically), one remedial action is to remedy the situation by replacing the impacted IoT which may take some time and effort especially for a critical functionality. Thus, reestablishing the critical functionality performed by an impacted IoT may become very important to a user, e.g., remotely controlling the temperature of a vacation home during winter months, remotely controlling the temperature of a critical appliance, and so on.

In one example, the present disclosure provides sensor devices that have the ability to monitor their core function(s) to detect an anomaly. For example, performance evaluations may comprise the evaluation of the accuracy of the sensor devices performing their core sensor function(s) such as the collection of data, e.g., taking measurements of external metrics via one or more sensors, use of the collected data to predict one or more future events (e.g., predicting a breach event of a restricted area, predicting a shortage event of at least one item, predicting a potential failure event, predicting a potential degradation event of a service, etc.) and/or use of the collected data to execute one or more assigned tasks (e.g., transmitting the collected data to a remote entity such as a remote application server, initiating an alarm signal, sending a report, etc.). In one example, a sensor device detecting an anomaly in its core sensor function may execute a migration process where its core sensor function can be migrated to one or more other surrounding or neighboring sensor devices in proximity to the affected sensor device, thereby preserving the affected sensor device's core sensor function.

More specifically, in one embodiment of the present disclosure each sensor device is deployed with an operating system (OS), one or more programmed or defined functions (e.g., sensor functions), and a sensor device managing module. For example, operating systems that are written for the IoTs are especially designed to perform within the strict constraints of the IoTs' limited capabilities. Often, these are embedded operating systems that enable IoTs to communicate with cloud services and other IoT devices over a communication network. In fact, such communications are achieved within the tight parameters of limited amounts of memory and processing power.

In one embodiment, the one or more programmed or defined functions of the IoTs comprise one or more specific data collection tasks and the ability to communicate the collected data to another entity. For example, such sensor devices often have very specific tasks to perform, e.g., reporting on a measured temperature, reporting on a measured humidity, reporting when a motion is detected, reporting when an access point is breached, reporting when an entity is detected within an image, reporting a physical location (e.g., reporting Global Positioning System (GPS) information), reporting on a measured speed, reporting on a measured acceleration, reporting on a distance traveled, reporting on measured biometric data (e.g., such as heart rate, breathing rate, blood oxygen level, blood pressure, blood sugar level, and so on) and the like. In one embodiment, the measured or collected data is stored locally at the sensor device until it is requested by another entity (e.g., a remote application server or another sensor device). In another embodiment, the measured or collected data is sent to another entity (e.g., a remote application server or another sensor device) once the data is captured by the sensor device, thereby reducing the need to deploy a large memory within the sensor device to hold a large volume of collected data.

In one embodiment of the present disclosure, each sensor device is deployed with a sensor device managing module (also referred to as an IoT manager (IM) herein). The sensor device managing module is tasked with the sole task of monitoring the sensor device to detect an anomaly within the sensor device. An “anomaly” is defined as an operational parameter being outside of its expected range, e.g., the operational parameter has deviated from it expected norm. To illustrate, a sensor device (e.g., sensor device A) may be a temperature sensing device that collects a measured temperature once per hour and will send an average of two consecutive measured temperatures once every two hours to another device (e.g., sensor device B or a remote application server). Thus, sensor device A may collect two temperature readings (e.g., 75 degrees at 2:00 pm and 85 degrees at 3:00 pm) and then report the average temperature reading (e.g., 80 degrees=(75+85)/2) to sensor device B. Thus, the sensor device managing module would only be tasked with monitoring these three distinct events of: 1) collecting a temperature reading every hour, 2) performing an averaging step (a calculating step) every two hours on two consecutive temperature readings, and 3) sending the average temperature reading every two hours to sensor device B. If the sensor device managing module detects any one of these three steps being performed incorrectly or is outside of an expected schedule, then the sensor device managing module will declare the detection of an anomaly.

In one embodiment, the sensor device managing module is isolated from any other functions performed by the sensor device. In other words, to prevent malicious codes infecting the sensor device managing module, memory isolation (also known as memory integrity) will be implemented for the sensor device managing module. For example, core isolation is a security feature of an OS that protects various important core software processes from malicious software by isolating them in memory. For example, the OS performs memory integrity by running those core processes in a virtualized environment. Memory integrity is one feature of core isolation which regularly verifies the integrity of the code running those core processes (e.g., the monitoring process performed by the present sensor device managing module) in an attempt to prevent any attacks from altering them. By using memory isolation on the sensor device managing module, there will be a greater confidence in believing that the sensor device managing module itself within the sensor device is still functioning probably even if the sensor device is compromised after a malicious attack.

In one embodiment, once the sensor device managing module detects an anomaly having occurred, the sensor device managing module will initiate one or more remedial actions. In one embodiment, the sensor device managing module may optionally instruct the OS to perform a diagnostic self-test (if available) which may discover one or more defects or degradations within the sensor device, e.g., a defective or degraded sensor, a defective or degraded transceiver, a defective or degraded power source, the presence of malicious codes, and the like. However, given the limited processing capability of the sensor device, such diagnostic self-test may not exist for a particular implementation. In another embodiment, the sensor device managing module may instruct the OS to perform a reset of the sensor device (e.g., powering the sensor device down and then powering the sensor device up). This resetting step can be performed in addition to or instead of the step of performing the diagnostic self-test. This resetting procedure may resolve the detected anomaly, e.g., a resetting of the memory to remove inadvertent codes inconsistency, or malicious codes from an attack.

Furthermore, in one embodiment if the anomaly is detected initially or subsequently after performing the diagnostic self-test and/or the resetting step, the sensor device managing module may initiate a sensor function migration process, where the core sensor function of the affected sensor device will be migrated to another sensor device. In other words, the sensing function performed by the sensor device will be transferred to another sensor device. To illustrate, if a sensor device is deployed to measure a temperature every hour within a refrigerator and an anomaly is deemed to have occurred within that sensor device, then the core sensor function (e.g., a temperature sensing function) can be migrated to another sensor device. In one example, the refrigerator may have a plurality of sensor devices deployed within the refrigerator (e.g., a sensor device A to measure the general interior temperature of the refrigerator, a sensor device B to measure the quantity of items within the refrigerator (e.g., using a camera, a thermal camera, or infrared camera for counting the number or quantity of each item stored inside of the refrigerator), a sensor device C to detect whether the door(s) of the refrigerator is in the closed position, and the like). If sensor device A is deemed to have suffered an anomaly (e.g., an unrecoverable anomaly), then sensor device A's temperature monitoring function can be migrated to sensor device B (i.e., provided that sensor device B has an appropriate sensor to perform the migrated sensor function of sensor device A). For example, a thermal camera of sensor device B used to determine the quantity of milk remaining inside a carton of milk can then also be used to determine the general temperature of the interior of the refrigerator previously being performed by sensor device A.

In one embodiment, a stored instance of the software codes pertaining to the core sensor function of each sensor device is also stored within the sensor device. The stored instance of the software codes may also be encrypted and/or compressed to ensure security and/or storage efficiency. For example, the sensor device A will transfer this stored instance of the software codes to the sensor device B. If the stored instance of the software codes is encrypted/compressed, then sensor device B will perform decryption/decompression to retrieve and instantiate the temperature sensing function of sensor device A. This will allow an attacked sensor device to seamlessly migrate its core sensor function to another sensor device within a locale of the sensor device A (e.g., within a direct device to device communication range of sensor device A (e.g., Bluetooth or the like)).

In one embodiment, sensor device managing module of sensor device A is also migrated to sensor device B. Thus, in one embodiment, after migration, sensor device B may have two (2) sensor device managing modules being instantiated at the same time with one monitoring the core sensor function of sensor device A and the second one monitoring the core sensor function of sensor device B. However, in one embodiment, after migration, sensor device B's sensor device managing module may be tasked with monitoring both the core sensor function of sensor device A and the core sensor function of sensor device B. In one embodiment, once the migration is completed, sensor device A may undergo a reformatting process to wipe out any residual malicious codes. In one embodiment, the migration may be reversed if the reformatted sensor device A is deemed to be functioning properly after the reformatting process is completed (e.g., reversing the sensor function migration from sensor device B back toward sensor device A). In one embodiment, the reversing of the sensor function migration from sensor device B back toward sensor device A may intentionally be delayed for a period of time, e.g., after one hour, after two hours, after 24 hours, and so on. This intentional delay may avoid the scenario where a malicious attack is an ongoing concern for a period of time.

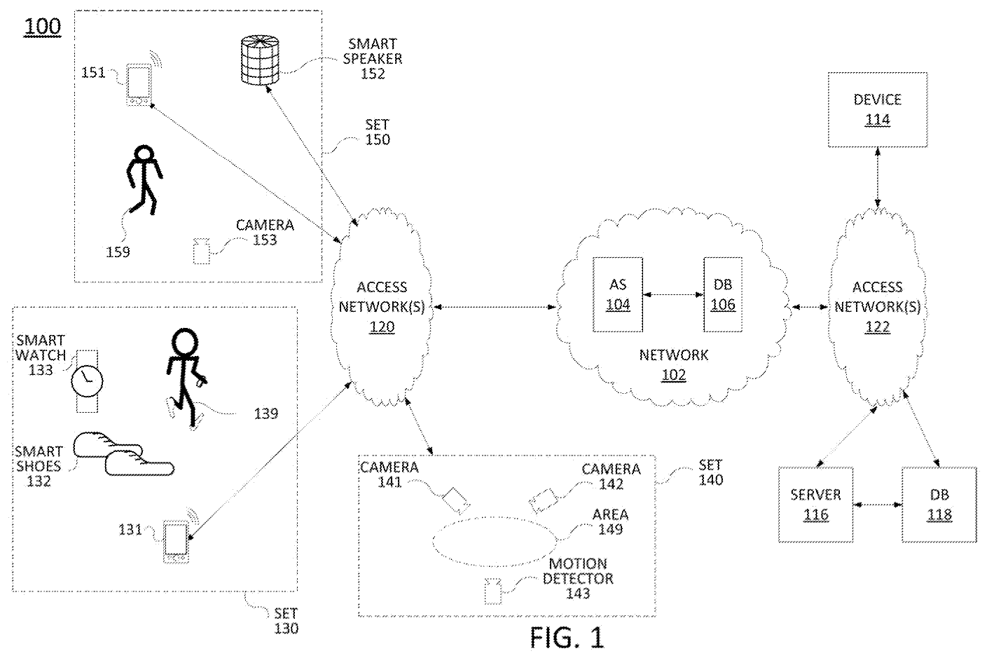

The benefits of the present sensor device core function migration provide a robust mechanism to minimize the disruption that may be caused by a malicious attack of the sensor devices. In other words, the sensor function of sensor device A is maintained elsewhere even though the physical sensor device A itself may no longer be functioning (at least for a period of time). Furthermore, such timely dynamic device to device migration will allow the overall sensor device community to address any potential attack as a collective group without the need for a centralized defense or recovery mechanism provided by a remote server. In other words, the overall sensor device community may bounce back quickly after a malicious attack. Furthermore, if sensor device A is permanently disabled (e.g., maliciously due to an attack or simply from a failure due to normal usage), there may not be a need to immediately replace sensor device A since sensor device A's core sensor function is still being implemented. For example, it may be difficult to find replacements for sensor device A because the malicious attacks may have damaged a very large number of sensor devices in a particular region of the country and so on. Thus, the present sensor device core function migration not only provides overall sensor function resiliency, but may also insulate against any potential supply chain issues that may be affecting a particular geographic region. These and other aspects of the present disclosure are discussed in greater detail below in connection with the examples of FIGS. 1-4.

To further aid in understanding the present disclosure, FIG. 1 illustrates an example system 100 in which examples of the present disclosure for protecting sensor devices may operate. The system 100 may include any one or more types of communication networks, such as a traditional circuit switched network (e.g., a public switched telephone network (PSTN)) or a packet network such as an Internet Protocol (IP) network (e.g., an IP Multimedia Subsystem (IMS) network), an asynchronous transfer mode (ATM) network, a wireless network, a cellular network (e.g., 2G, 3G, 4G, 5G and the like), a long term evolution (LTE) network, and the like, related to the current disclosure. It should be noted that an IP network is broadly defined as a network that uses Internet Protocol to exchange data packets. Additional example IP networks include Voice over IP (VOIP) networks, Service over IP (SoIP) networks, and the like.

In one example, the system 100 may comprise a core network 102. The core network 102 may be in communication with one or more access networks 120 and 122, and the Internet (not shown). In one example, core network 102 may combine core network components of a cellular network with components of a triple play service network; where triple-play services include telephone services, Internet services and television services to subscribers. For example, core network 102 may functionally comprise a fixed mobile convergence (FMC) network, e.g., an IP Multimedia Subsystem (IMS) network. In addition, core network 102 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VOIP) telephony services. Core network 102 may further comprise a broadcast television network, e.g., a traditional cable provider network or an Internet Protocol Television (IPTV) network, as well as an Internet Service Provider (ISP) network. In one example, core network 102 may include a plurality of television (TV) servers (e.g., a broadcast server, a cable head-end), a plurality of content servers, an advertising server (AS), an interactive TV/video-on-demand (VoD) server, a streaming server, and so forth. For ease of illustration, various additional elements of core network 102 are omitted from FIG. 1.

In one example, the access networks 120 and 122 may comprise Digital Subscriber Line (DSL) networks, public switched telephone network (PSTN) access networks, broadband cable access networks, Local Area Networks (LANs), wireless access networks (e.g., an IEEE 802.11/Wi-Fi network and the like), cellular access networks, 3rd party networks, and the like. For example, the operator of core network 102 may provide a cable television service, an IPTV service, or any other types of telecommunication service to subscribers via access networks 120 and 122. In one example, the access networks 120 and 122 may comprise different types of access networks, may comprise the same type of access network, or some access networks may be the same type of access network and other may be different types of access networks. In one embodiment, the core network 102 may be operated by a telecommunication network service provider. The core network 102 and the access networks 120 and 122 may be operated by different service providers, the same service provider or a combination thereof, or may be operated by entities having core businesses that are not related to telecommunications services, e.g., corporate, governmental or educational institution LANs, and the like. In one example, each of access networks 120 and 122 may include at least one access point, such as a cellular base station, non-cellular wireless access point, a digital subscriber line access multiplexer (DSLAM), a cross-connect box, a serving area interface (SAI), a video-ready access device (VRAD), or the like, for communication with various endpoint devices.

In one example, the access networks 120 may be in communication with various sensor devices in sensor device sets 130, 140, and/or 150. Similarly, access networks 122 may be in communication with one or more devices, e.g., device 114, server 116, database (DB) 118, etc. Access networks 120 and 122 may transmit and receive communications between sensor devices in sensor device sets 130, 140, and/or 150, and server 116 and/or database (DB) 118, application server (AS) 104 and/or database (DB) 106, other components of core network 102, devices reachable via the Internet in general, and so forth.

In one example, a first sensor device set 130 may include a mobile computing device 131, e.g., a cellular smartphone, a non-cellular wireless communication device (e.g., a tablet computing device, a Wi-Fi device, etc.), or the like. In accordance with the present disclosure, mobile computing device 131 may include one or more sensors for tracking location, speed, distance, altitude, or the like (e.g., a Global Positioning System (GPS) unit), for tracking orientation (e.g., gyroscope and compass), and so forth. As illustrated in FIG. 1, the first sensor device set 130 may further include smart shoes 132 (e.g., shoes with one or more embedded sensors for tracking distance traveled, stride length, contact pressure, steps taken, and/or other metrics) and a smart watch 133, which may comprise one or more sensors for tracking location, speed, distance, altitude, steps taken, or the like (e.g., a GPS unit), for tracking orientation (e.g., gyroscope and compass), for measuring heart rate/pulse, skin conductance, blood oxygen, or the like, and so forth.

In one example, each of these sensor devices (mobile computing device 131, smart shoes 132, and smart watch 133) may communicate independently with access networks 120 or locally with each other via device to device communication. In another example, one or more of these sensor devices may comprise a peripheral device that may communicate with remote devices, application servers, or the like via access networks 120, network 102, etc. via another endpoint device. For instance, smart shoes 132 may be paired with the mobile computing device 131 via a near-field connection, such as IEEE 802.15 based communications (e.g., Bluetooth or the like), where mobile computing device 131 may have a cellular or non-cellular wireless connection to access networks 120. Thus, in one example, smart shoes 132 may upload data to server 116 via mobile computing device 131, access networks 120, etc. In one example, mobile computing device 131 may include an application (app) for pairing with smart shoes 132, for establishing communication with server 116 to upload data from smart shoes 132, and so forth. In one example, smart watch 133 may be similarly paired with mobile computing device 131 via a near-field connection.

In another example, a second sensor device set 140 may include a plurality of motion sensors, or motion detection sensors, e.g., camera 141, camera 142, and motion detector 143. As illustrated in FIG. 1, each of these sensor devices may have an overlapping area 149 within the respective field-of-view of each device. As in the previous example, each of the camera 141, camera 142, and motion detector 143 may have separate connections to access networks 120 (e.g., via cellular or non-cellular links with a wireless access point, or via wired connection with an access point of access networks 120). However, in another example, one or more of the camera 141, camera 142, or motion detector 143 may have a wired or wireless connection to another local device (e.g., another sensor device) that may have a connection to access networks 120. For instance, camera 142 may be in communication with camera 141, which may have a connection to access networks 120 (e.g., where camera 142 does not have an independent connection to access networks 120), or both of the cameras 141 and 142 may be in communication with another device (not shown), such as a smart home hub, which may have a connection to access networks 120.

In still another example, a third sensor device set 150 may include a mobile computing device 151, e.g., a cellular smartphone, a non-cellular wireless communication device (e.g., a tablet computing device, a Wi-Fi device, etc.), or the like. In accordance with the present disclosure, mobile computing device 151 may include a virtual assistant application. The third sensor device set 150 may also include a smart speaker 152 (e.g., including another virtual assistant application) and a smart camera 153 (e.g., including yet another virtual assistant application). For instance, these virtual assistant applications may perform similar tasks, which may include wake word detection, or speaker identification/detection, such as distinguishing user 159 from others speakers, among other capabilities.

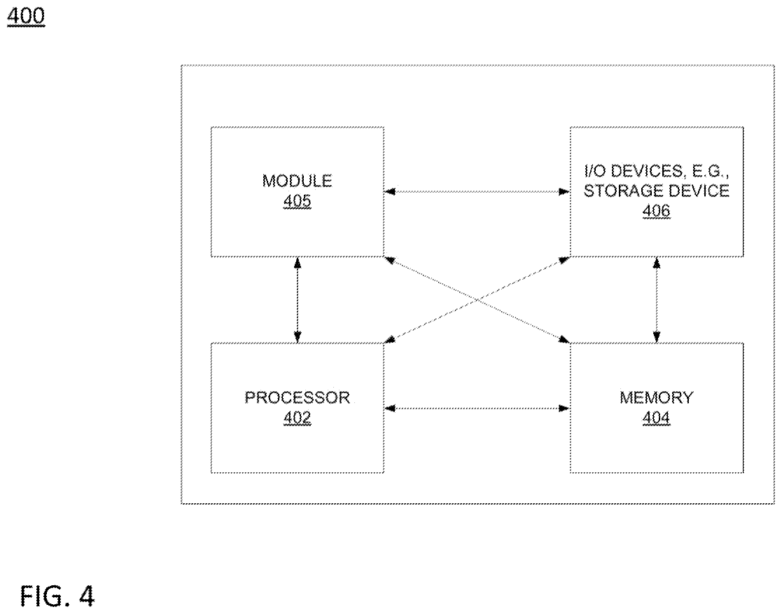

In one example, any one or more of the sensor devices in sensor sets 130, 140, or 150 may each comprise programs, logic or instructions for protecting sensor devices as described herein. For example, any of such devices may each comprise a computing system or device, such as computing system 400 depicted in FIG. 4, and may be configured to provide one or more operations or functions for protecting sensor devices.

It should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 4 and discussed below) or multiple computing devices collectively configured to perform various steps, functions, and/or operations in accordance with the present disclosure.

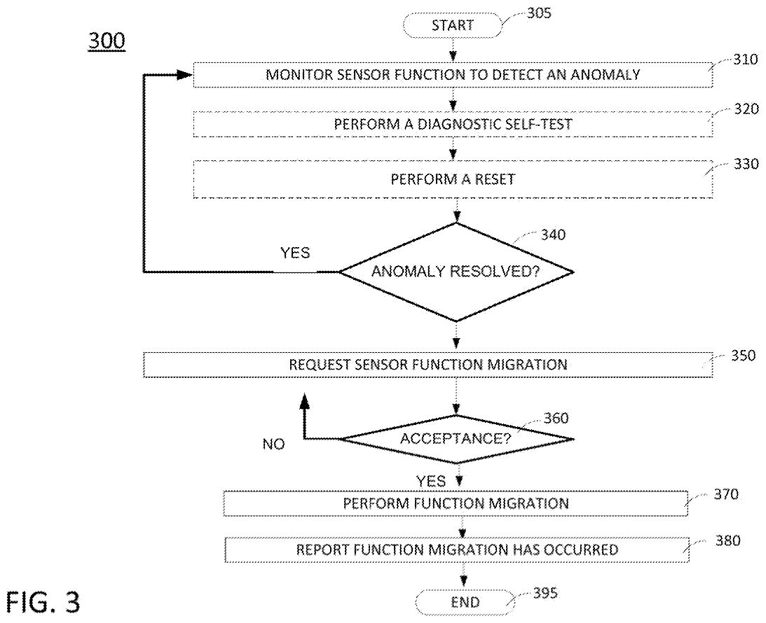

As illustrated in FIG. 1, access networks 122 may be in communication with a server 116 and a database (DB) 118. In accordance with the present disclosure, server 116 may comprise a computing system or server, such as computing system 400 depicted in FIG. 4, and may be configured to perform operations or functions for protecting sensor devices (such as illustrated and described in connection with the example method 300 of FIG. 3). For instance, server 116 may comprise a sensor device performance assessment server. In one example, DB 118 may comprise a physical storage device integrated with server 116 (e.g., a database server), or attached or coupled to the server 116, to store various types of information in support of systems for protecting sensor devices, in accordance with the present disclosure. For example, DB 118 may store data from various sensor devices (e.g., sensor devices in any one or more of sensor sets 130, 140, or 150), which may be used by server 116 to determine the accuracies of different sensor devices (e.g., whether a sensor device is performing its core sensor function properly, e.g., consistent with expectations). In addition, DB 118 may also store rankings/ratings/priority of different sensor device types/models, e.g., indexed by model ID, or the like. Furthermore, in one embodiment DB 118 may also store a plurality of software codes for various sensor devices. Thus, in the event that a sensor device is reformatted (e.g., after an anomaly was detected for the sensor device), the pertinent software code for the sensor device can be retrieved from DB 118 to be downloaded to the reformatted sensor device to restore the operation of the reformatted sensor device. In other words, if the sensor device is infected with malicious codes from a malicious attack, the reformatting with the restoration of the pertinent software codes from DB 118 may quickly restore the core sensor function of the infected sensor device.

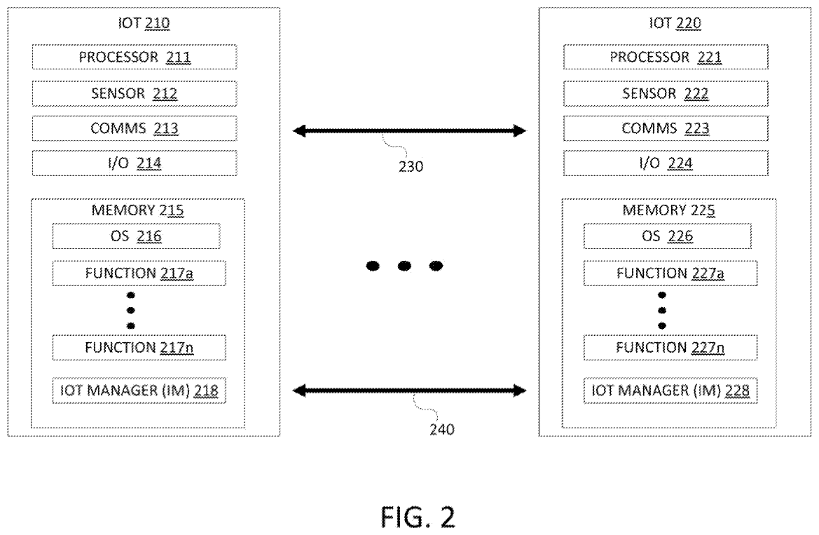

In an illustrative example, server 116 may be tasked with collecting sensor data, determining performance accuracies of different sensor device types/models, and publishing reports indicative of the performance accuracies of the different sensor device types/model. For instance, servers 116 may collect sensor data from mobile computing device 131, smart shoes 132, and smart watch 133 and store such sensor data in DB 118. Alternatively, or in addition, computing device 131, smart shoes 132, and/or smart watch 133 may upload such sensor data to DB 118. Over a period of time, server 116 may retrieve the respective sensor data, from which server 116 may determine a performance accuracy of one or more of the sensor devices, e.g., with respect to the sensor data of a reference sensor device. For instance, the smart watch 133 may be established as a “standard,” or reference sensor device, e.g., at least with respect to the metric of interest of “average stride length.” Thus, the sensor data of smart watch 133 comprising “stride length” data may be taken as a reference data set. A similar set of data may also be collected from smart shoes 132 over the same time period. The stride length metrics may be stored in DB 118, and may be accessed by server 116, which may determine a discrepancy between the data set from the smart watch 133 and the data set from the smart shoes 132. For instance, the average stride lengths over rolling 1 minute periods may be determined. In addition, an average of the discrepancies, e.g., over 50 time periods, 100 time periods, etc. may be calculated. The average discrepancy between the average stride length as determined by the smart watch 133 and the average stride length as determined by smart shoes 132 may then be determined and reported (e.g., between sensor devices). Such reporting between the sensor devices may precede the sensor function migration process as discussed above, e.g., migrating the stride monitoring function from the smart shoes 132 to the smart watch 133 or vice versa. In other words, in one embodiment the IM of one sensor device may detect an anomaly and decide to execute a sensor function migration process to transfer the sensor function of the affected sensor device to another unaffected sensor device, e.g., migrating the sensor function of the smart shoes 132 to the smart watch 133 or vice versa. Illustrative communications between sensor devices are depicted in FIG. 2 and discussed in greater detail below.

In one example, the report may be provided to a user of the devices in set 130, e.g., user 139. For instance, the report may be provided in a message to mobile computing device 131. In one example, the report may alternatively or additionally be provided to other users, such as a user of device 114. For instance, device 114 may access a website that rates and/or makes available for purchase one or more sensor device models, including at least a sensor device model of the smart shoes 132 (e.g., a particular make and model of smart shoes). In one example, the website may be hosted by server 116, or server 116 may provide a report regarding smart shoes 132 to another server or servers hosting such a website.

In another example, server 116 may collect and store (e.g., in DB 118) sensor data in the form of motion detection data from camera 141, camera 142, and motion detector 143. In this example, camera 141 may be a priority sensor device relative to the camera 142 and the motion detector 143. For example, camera 141 may be tasked with capturing facial information of individuals traversing through a monitored area 149, whereas camera 142 is tasked with capturing body temperature of individuals traversing through the monitored area 149, and motion detector 143 may be tasked with capturing motion information of individuals traversing through the monitored area 149 (e.g., the detected motion can be used as a trigger signal to activate one or more of: the camera 141, the camera 142, an access door latch, a speaker to broadcast a recorded message, a ticket dispenser to provide one or more tickets, and the like). In one example, cameras 141 and 142 may be similar, but may be different models from the same or different manufacturers, for instance. In one example, cameras 141 and 142 may include internal motion detection sensors that activate video recording. In such case, the motion detection data may comprise a time series indicating whether there is motion detected or not detected (or whether the respective camera has been activated or not). In another example, camera 141 and/or camera 142 may have a continuous active video capture, from which motion detection may be performed via a machine learning (ML)-based algorithm or other computer-implemented video analysis. On the other hand, for illustrative purposes, motion detector 143 may comprise an infrared or other line-of-sight light-based motion detector (e.g., a light-trip sensor). Thus, although motion detector 143 may operate in an entirely different manner from cameras 141 and 142, the collected sensor data is of the same format (e.g., time series indicative of whether motion was detected at any given time within area 149 or not).

In one embodiment, the performance accuracies of cameras 141, 142 and/or motion detector 143 may be determined by server 116 via a comparison of the motion sensor data of cameras 141, 142 and/or motion detector 143. In addition, server 116 may report on the performance accuracy, or accuracies to an owner or operator of the sensor device set 140, to a website for rating and/or facilitating purchases of device models of cameras 141, 142 and/or motion detector 143, to other users, such as a user of device 114 seeking information on such device model(s), and so forth.

In one example, the IM of camera 141 may detect an anomaly and decide to execute a sensor function migration process to transfer the sensor function of the affected sensor device (e.g., camera 141) to another unaffected sensor device (e.g., camera 142 or motion detector 143 which may also have a camera), e.g., migrating the sensor function of the camera 141 to the camera 142 or motion detector 143. It should be noted that in one embodiment the sensor function of the camera 141 can be distributed between the camera 142 and the motion detector 143, e.g., since both camera 142 and motion detector 143 may have limited processing capability and memory resources, the added sensor function of camera 141 may need to be shared by both camera 142 and motion detector 143 in order to perform all three sensor functions of these three sensor devices. However, if the migrated sensor function of camera 141 is simply too computationally demanding, then the “receiving” sensor device may stop performing its own assigned sensor function due to the fact that the migrated sensor function of camera 141 has a higher priority ranking relative to its own assigned sensor function. The priorities of these sensor devices can be set by the operating entity who is managing the monitored area 149. In fact, in one embodiment the “receiving” sensor device may jettison (e.g., delete) its own assigned sensor function software code from the memory in order to make available the necessary memory space to accommodate the migrated sensor function of camera 141. Such drastic steps may be necessary since the sensor devices are often implemented using relatively inexpensive and low capability hardware devices. In the scenario where the affected sensor device (e.g., camera 141) is subsequently reformatted, the migrated sensor function of camera 141 can be subsequently returned to camera 141 after the reformatting process is completed. In turn, if the “receiving” sensor device has deleted its own assigned sensor function software code from the memory, then the “receiving” sensor device may recover such deleted sensor function software if it has a stored compressed version of the sensor function software. Otherwise, the “receiving” sensor device may recover such deleted sensor function software from DB 118. However, if the affected sensor device has a lower priority ranking relative to other sensor devices in the proximal or immediate area (e.g., within a direct machine to machine communication distance) and the surrounding sensor devices cannot accommodate an additional sensor function of the affected sensor device, then the sensor function migration process will not occur. In other words, priority information of the affected sensor device may be exchanged or shared with other sensor devices before the sensor function migration process is implemented. In this manner, assigned priority ranking of an affected sensor device may impact the execution of the sensor function migration process.

With respect to the third sensor device set 150, a virtual assistant application of mobile computing device 151 may comprise a sensor device, e.g., for voice identification/recognition. In this example, server 116 may collect data from mobile computing device 151 and smart speaker 152, which may be deployed in the same environment, such as within the same room. For instance, the data (e.g., “sensor data”) may be regarding whether a human speaker is detected, and the determined identity of the speaker (for instance, distinguishing user 159 from other members of a family or from non-family members who may be present and speaking). As such, server 116 may determine the performance accuracy of smart speaker 152 by comparison of the speaker detection/identification data of smart speaker 152 to that of the stored reference speaker data in DB 118. Alternatively, mobile computing device 151 may determine the performance accuracy of smart speaker 152 by comparison of the speaker detection/identification data of smart speaker 152 to that of the stored reference speaker data in mobile computing device 151.

Similar to the above examples, server 116 may report on the performance accuracy of smart speaker 152 to an owner or operator of the device set 150 (e.g., user 159), to a website for rating and/or facilitating purchases of the device model of smart speaker 152, to other users, such as a user of device 114 seeking information on such device model, and so forth. It should be noted in connection with this example that the particular detected identity or identities of speakers are not required to be shared with servers 116, but may be tagged by a non-personally identifiable user ID, such as user 1, user 2, user 3, etc. and where server 116 and/or DB 118 does not store such speaker identification data any longer than necessary to calculate the accuracy of the virtual assistant of smart speaker 152. Furthermore, such analysis would be performed only when the user has authorized or opted into this monitoring and analysis service to protect the data privacy of the user.

In one embodiment, the third sensor device set 150 may also deploy a camera 153 with a microphone and a speaker, e.g., camera 153 may be part of a home security system. In one example, the smart speaker 152 may detect an anomaly and decide to execute a sensor function migration process to transfer the sensor function of the affected sensor device (e.g., smart speaker 152) to another unaffected sensor device (e.g., camera 153), e.g., migrating the sensor function of the smart speaker 152 to the camera 153. Thus, various sensor devices within an enclosed environment such as a home, a place of business, or a place of educational instructions can provide mutual protection against a malicious attack.

Although only a single server 116 and a single DB 118 are illustrated, it should be noted that any number of servers 116 or databases 118 may be deployed. In one example, core network 102 may also include an application server (AS) 104 and a database (DB) 106. In one example, AS 104 may perform the same or similar functions as server 116. Similarly, DB 106 may store the same or similar information as DB 118 (e.g., sensor device data, rankings of sensor device types, priorities of sensor device types, sensor function codes, etc.). For instance, core network 102 may provide a service to subscribing websites and/or user devices in connection with protecting sensor devices, e.g., in addition to television, phone, media streaming, Internet access, and/or other telecommunication services. In one example, AS 104, DB 106, server 116, and/or DB 118, or any one or more of such devices in conjunction with one or more of devices in sensor device sets 130, 140, and/or 150, may operate in a distributed and/or coordinated manner to perform various steps, functions, and/or operations described herein.

In this regard, it should be noted that in another example, aspects of the foregoing described in connection with server 116 may alternatively or additionally be performed by sensor devices in sensor device sets 130, 140, and/or 150. As just one example, mobile computing device 131 may collect its own measurements/sensor data, and may collect similar measurements/sensor data regarding the same external metric, e.g., speed of movement of user 139, distance traveled, stride length, etc. from smart shoes 132 and smart watch 133. Mobile computing device 131 may then determine the performance accuracy of either or both of smart shoes 132 or smart watch 133 by way of comparison to mobile computing device 131's own measurements as reference sensor data. In addition, mobile computing device 131 may report on the performance accuracy, or accuracies, e.g., to server 116, to an independent website and/or a website associated with server 116, to AS 140, to device 114, to the user 139, etc.

It should be noted that the system 100 has been simplified. Thus, the system 100 may be implemented in a different form than that which is illustrated in FIG. 1, or may be expanded by including additional endpoint devices, access networks, network elements, application servers, etc. without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements. For example, the system 100 may include other network elements (not shown) such as border elements, routers, switches, policy servers, security devices, gateways, a content distribution network (CDN) and the like. For example, portions of core network 102 and/or access networks 120 and 122 may comprise a content distribution network (CDN) having ingest servers, edge servers, and the like, for packet-based streaming of videos or video segments that may be provided in accordance with the present disclosure. Similarly, although only two access networks 120 and 122 are shown, in other examples, access networks 120 and/or 122 may each comprise a plurality of different access networks that may interface with core network 102 independently or in a chained manner. For example, device 114 and server 116 may access core network 102 via different access networks, devices 110 and 112 may access core network 102 via different access networks, and so forth. Thus, these and other modifications are all contemplated within the scope of the present disclosure.

FIG. 2 illustrates examples of sensor devices and sensor device to sensor device communications. More specifically, FIG. 2 illustrates two sensor devices (e.g., IoT 210 and IoT 220). Each of the sensor devices comprises a processor 211 or 221, one or more sensors 212 or 222, communication hardware (e.g., Comms such as transceivers) 213 or 223, I/O devices or interfaces 214 or 224 and a memory 215 or 225.

For each of the sensor devices 210 and 220, the processor 211 or 221 is in communication with the sensor(s) 212 or sensor 222, I/O device(s) 214 or 224, and communication hardware 213 or 223 having one or more communication interfaces. The sensor(s) 212 or 222 may comprise one or more different types of sensors that are configured to detect various conditions. For instance, the sensor(s) may include at least one of: an imaging sensor (e.g., a camera), an audio sensor (e.g., a microphone), a temperature sensor (e.g., a thermometer or an infrared camera), a pressure sensor, an accelerometer, a motion sensor, a salinity sensor, a pH sensor, an ionic strength sensor, a droplet crystallinity sensor, a biometric sensor (e.g., a sensor capable of measuring a person's pulse rate, blood oxygen level, blood alcohol content, blood pressure, body temperature, skin conductivity, blood glucose level, or other biometric parameters), and/or any other types of sensors.

The I/O device(s) 214 or 224 may comprise one or more devices configured to present information and/or to receive inputs. In one example, the I/O device(s) may comprise one or more of: a display, a speaker, a microphone, a touch screen, one or more input buttons, an input pad, or a haptic feedback device. For instance, display elements embedded in the surface of a device may allow messages (e.g., text and/or images) to be displayed on the surface of the device. A haptic feedback element embedded in the device may allow haptic feedback, such as a slight rumble or vibration, to be emitted by the device.

The communication interface(s) of communication hardware 213 or 223 may comprise a wireless communication device (e.g., a WiFi transceiver, a Bluetooth transceiver, or the like) that allows the sensor devices to communicate with the AS 104, the server(s) 116, and/or other sensor devices. For instance, the communication interface(s) may allow the sensor devices to share information collected by the sensor devices with the AS 104, the server(s) 116, and/or with other sensor devices. The communication interface(s) may also allow the sensor devices to receive data from the AS 104, the server(s) 116, and/or with other sensor devices.

In embodiment, each memory 215 or 225 comprises an OS 216 or OS 226, one or more sensor functions 217a-n or 227a-n (e.g., sensor function software codes), and a sensor device managing module 218 or 228 (e.g., sensor device managing software codes). The one or more sensor functions 217a-n or 227a-n may comprise the measuring, storing, receiving, and/or transmitting of: an image, a video, an audio signal, a temperature, a pressure, a speed, an acceleration, a motion, a salinity, a pH, an ionic strength, a crystallinity, or a biometric (e.g., a pulse rate, a blood oxygen level, a blood alcohol content, a blood pressure, a body temperature, a skin conductivity, a blood glucose level, or any other biometric parameters). Broadly, a sensor function comprises any sensor functions performed by a sensor device. As such, the above listing is only illustrative.

In one embodiment, the software codes for the one or more sensor functions are executed by the processor 211 or 221 in the memory 215 or 225. Furthermore, in one embodiment, an encrypted/compressed version of the sensor function software codes are also stored in a non-volatile memory of the sensor device. To illustrate, in one example when IM 218 detects an anomaly within sensor device 210 (broadly an affected sensor device), the IM 218 may implement a sensor function migration process to transfer one or more sensor functions of the affected sensor device (e.g., sensor device 210) to another unaffected sensor device (e.g., sensor device 220 (broadly a hosting sensor device)). In doing so, the encrypted/compressed version of the sensor function software codes for one or more sensor functions 217a-n are exported to sensor device 220 via a dedicated communication channel 240 in lieu of a regular or normal communication channel 230. The use of the encrypted/compressed version of the sensor function software codes provides two advantages. First, the encrypted/compressed version of the sensor function software codes would likely escape attack from the malicious actors, i.e., the sensor function software codes would not be infected with malicious codes. Second, the encrypted/compressed version of the sensor function software codes would likely be more compact such that the migration can be effected quickly and efficiently.

Additionally, the regular or normal communication channel 230 is the channel that is regularly used to receive/transmit measured sensor data to and from the server 104 or server 116 in the network 102 or between the sensor devices. However, if an anomaly is detected, there is a likely possibility that the communication channel 230 may be comprised or monitored by malicious actors. As such, the sensor function migration process is implemented via a dedicated secured communication channel that is distinct from the regular or normal communication channel 230. Thus, it would be more difficult for the malicious actors to detect the migration of the sensor function(s) away from the sensor device 210. Otherwise, the malicious actors may also attack the “receiving” sensor device 220 as well. The dedicated secured communication channel 240 may employ a distinct frequency or a distinct protocol known between the various sensor devices. Alternatively, the dedicated secured communication channel 240 may further use encryption such as encryption key pairs and the like.

Additionally, prior to the sensor function migration process being initiated, the IM 218 and IM 228 may negotiate the sensor function migration process. For example, IM 218 may send a broadcast message to surrounding sensor devices of its need to migrate its core sensor function(s) due to the detection of an anomaly at sensor device 210. The broadcast message may include one or more of: the identity of sensor device 210, the core sensor function(s) of sensor device 210 to be migrated, the hardware and software requirements for the migration (e.g., computing power of the processor, power requirement, memory storage requirement, sensing capability of the sensor device, current OS version requirement, and so on), sensor device priority and the like. In one example, when the IM 228 of sensor device 220 determines that it is able to host the migration of the core sensor function(s) of sensor device 210, it will notify the IM 218 to initiate the sensor function migration process. In one embodiment, the IM 218 itself is also migrated from the sensor device 210 to sensor device 220.

FIG. 3 illustrates a flowchart of an example method 300 for protecting a sensor device, in accordance with the present disclosure. In one example, the method 300 is performed by a component of the system 100 of FIG. 1, such as by server 116, application server 104, a device in one of sensor device sets 130, 140, or 150, and/or any one or more components thereof (e.g., a processor, or processors, performing operations stored in and loaded from a memory), by a plurality of the devices in sensor device sets 130, 140, or 150, server 116, or application server 104, or by any one or more of such devices in conjunction with one or more other devices, such as DB 106, DB 118, and so forth. In one example, the steps, functions, or operations of method 300 may be performed by a computing device or system 400, and/or processor 402 as described in connection with FIG. 4 below. For instance, the computing device or system 400 may represent any one or more components of a device, server, and/or application server in FIG. 1 that is/are configured to perform the steps, functions and/or operations of the method 300. Similarly, in one example, the steps, functions, or operations of method 300 may be performed by a processing system comprising one or more computing devices collectively configured to perform various steps, functions, and/or operations of the method 300. For instance, multiple instances of the computing device or processing system 400 may collectively function as a processing system. For illustrative purposes, the method 300 is described in greater detail below in connection with an example performed by a processing system. The method 300 begins in step 305 and proceeds to step 310.

At step 310, the processing system monitors one or more sensor functions to detect an anomaly for a sensor device, e.g., monitoring a performance of at least one sensor function to detect an anomaly. For example, the sensor device managing module or IM of a sensor device may monitor its own sensor device performance, e.g., the accuracy of its measurements, the timely execution of a task based on the measurements, the timely storage of the measurements, the timely transmission of the measurements, the transmission of the measurements to a proper recipient, and the like. In one embodiment, an anomaly is detected in step 310, e.g., measurements are not being taken in a timely manner, measurements are not being stored in a timely manner, measurements are not being transmitted in a timely manner, measurements are not being transmitted to a proper recipient, and the like. In other words, method 300 detects an anomaly in the performance of the at least one sensor function.

At optional step 320, the processing system performs a diagnostic self-test in response to detecting the anomaly for the sensor device. For example, a self-test is conducted to determine whether the sensor device is currently performing within the designed specification. If the sensor device does not have self-testing capability, then step 320 is skipped.

At optional step 330, the processing system performs a reset (or a reboot) in response to the detecting of the anomaly for the sensor device in step 310 and/or detecting a problem resulting from performing the diagnostic self-test of step 320. The reset may comprise powering down the sensor device, waiting a short period of time, and then powering up the sensor device. The reset may clear certain unintentional faults that may arise from the normal operations of the sensor device or removing certain malicious codes from the volatile memory. Step 330 can be deemed optional if the detected anomaly from step 310 or the detected problem from step 320 cannot be fixed with a reset procedure.

At step 340, the processing system determines whether the detected anomaly for the sensor device in step 310 and/or the detected problem resulting from performing the diagnostic self-test of step 320 is still present. If the anomaly for the sensor device in step 310 and/or the detected problem resulting from performing the diagnostic self-test of step 320 is no longer present, method 300 returns to step 310 to continue the monitoring for another anomaly. If the anomaly for the sensor device in step 310 and/or the detected problem resulting from performing the diagnostic self-test of step 320 is still present, method 300 proceeds to step 350 to initiate the sensor function migration process.

At step 350, the processing system initiates the sensor function migration process by sending a request to surrounding sensor devices to request for sensor function migration, i.e., to host one or more sensor functions of the affected sensor device. In other words, method 300 sends a request to at least one neighboring sensor device to host at least one sensor function of the affected sensor device. For example, as illustrated above IM 218 may send a broadcast message to surrounding sensor devices of its need to migrate its core sensor function(s) due to the detection of an anomaly at sensor device 210. The broadcast message may include one or more of: the identity of sensor device 210, the core sensor function(s) of sensor device 210 to be migrated, the hardware and software requirements for the migration (e.g., computing power of the processor, power requirement, memory storage requirement, sensing capability of the sensor device, current OS version requirement, and so on), sensor device priority and the like. In other words, the request may comprise at least one of: an identity of sensor device 210, a description of the at least one sensor function of the sensor device 210, a hardware requirement necessary to support the at least one sensor function of the sensor device 210, a software requirement necessary to support the at least one sensor function of the sensor device 210, or a priority ranking of the sensor device 210.

At step 360, the processing system determines whether the request has been accepted by one or more other neighboring sensor devices. In one embodiment, if the request is not accepted, the method returns to step 350 to continue to wait for an acceptance. In one embodiment, if the request is accepted, the method proceeds to step 370. In other words, the method 300 may receive an acceptance (e.g., a reply message) to the request from at least one neighboring sensor device to host at least one sensor function of the affected sensor device.

At step 370, the processing system performs the sensor function migration process, e.g., identifying the one or more “receiving” sensor devices that will host the migrated sensor function(s). In one embodiment, the identifying further includes verifying the identity and credentials of the “receiving” sensor device(s). For example, a neighboring sensor device that has been previously registered with the affected sensor device may be deemed to be an acceptable hosting sensor device. In other words, to insulate against the possible scenario where a malicious actor attacks a sensor device and then poses as a potential rescue sensor device to accept the migrated sensor function(s), the present method must ensure that the potential hosting sensor device is on an approved list of approved hosting sensor devices. Once the potential hosting sensor device is vetted and approved for hosting the migration, the sensor function(s) of the affected sensor device is transferred to the one or more hosting sensor devices. In other words, method 300 transfers a software code of at least one sensor function to at least one neighboring sensor device. Again, it is possible that the migrated sensor function(s) can be supported by two or more neighboring hosting sensor devices. In one embodiment, the sensor device managing module of the affected sensor device (e.g., the software code of the sensor device managing module of the affected sensor device) is also migrated to the hosting sensor device.

At step 380, the processing system reports that the sensor function migration process has occurred and has been completed. Namely, the sensor function migration process can be dynamically initiated by each sensor device without any central planning or coordination. Since such sensor devices are often deployed in a remote location and having very limited processing capabilities, a timely migration of their sensor function(s) may provide a high level of resiliency and robustness against persistent attacks. Thus, once the sensor function migration process has occurred and has been completed, it may be necessary to inform a centralized system, e.g., server 104 or server 116 or even a user (e.g., user 139, user 159 or user of device 114) of the sensor function migration. The reporting may include various information, e.g., ID and/or location of the affected sensor device, the ID and/or location of the hosting sensor device, the time that the migration occurred, the steps taken (if any, such as self-testing, resetting, and the like) prior to the migration, the nature of the anomaly (e.g., if the sensor device was not taking measures, if the sensor device was not sending measures as expected, if the sensor device was sending the measures to the wrong recipient, and the like), and the like. Method 300 ends in step 395.

It should be noted that the method 300 may be expanded to include additional steps, or may be modified to replace steps with different steps, to combine steps, to omit steps, to perform steps in a different order, and so forth. For instance, in one example the processor may repeat one or more steps of the method 300 over different periods of a day or week to ascertain whether the anomaly is purely intermittent, e.g., an non-malicious interference such as a passing vehicle such a passing train or an electric brown out situation during high electricity usage in the area. In one example, the method 300 may also include the step of requesting assistance from server 104 or server 116 if no surrounding sensor device is willing to host the sensor function of the affected sensor device. For example, the server 104 or server 116 may optionally elevate the priority ranking of the affected sensor device so that neighboring sensor devices would then attempt to host the sensor function of the affected sensor device due to its higher priority ranking. Alternatively, the server 104 or server 116 may optionally submit a work order ticket to send a technician to the pertinent location to replace the affected sensor device. Alternatively, the server 104 or server 116 may optionally activate one or more reserved sensor devices in the pertinent location to replace or to assist the affected sensor device, e.g., permanently shutting down the affected sensor device and activating a new sensor device to perform the sensor function of the affected sensor device. Thus, these and other modifications are all contemplated within the scope of the present disclosure.

In addition, although not expressly specified above, one or more steps of the method 300 may include a storing, displaying and/or outputting step as required for a particular application. In other words, any data, records, fields, and/or intermediate results discussed in the method can be stored, displayed and/or outputted to another device as required for a particular application. Furthermore, operations, steps, or blocks in FIG. 3 that recite a determining operation or involve a decision do not necessarily require that both branches of the determining operation be practiced. In other words, one of the branches of the determining operation can be deemed as an optional step. Furthermore, operations, steps or blocks of the above described method(s) can be combined, separated, and/or performed in a different order from that described above, without departing from the example embodiments of the present disclosure.

FIG. 4 depicts a high-level block diagram of a computing device or processing system specifically programmed to perform the functions described herein. For example, any one or more components or devices illustrated in FIG. 1 or described in connection with the examples of FIG. 2 or 3 may be implemented as the processing system 400. As depicted in FIG. 4, the processing system 400 comprises one or more hardware processor elements 402 (e.g., a microprocessor, a central processing unit (CPU) and the like), a memory 404, (e.g., random access memory (RAM), read only memory (ROM), a disk drive, an optical drive, a magnetic drive, and/or a Universal Serial Bus (USB) drive), a module 405 for protecting a sensor device, and various input/output devices 406, e.g., a camera, a video camera, storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like).

Although only one processor element is shown, it should be noted that the computing device may employ a plurality of processor elements. Furthermore, although only one computing device is shown in the Figure, if the method(s) as discussed above is implemented in a distributed or parallel manner for a particular illustrative example, i.e., the steps of the above method(s) or the entire method(s) are implemented across multiple or parallel computing devices, e.g., a processing system, then the computing device of this Figure is intended to represent each of those multiple specific-purpose computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 402 can also be configured or programmed to cause other devices to perform one or more operations as discussed above. In other words, the hardware processor 402 may serve the function of a central controller directing other devices to perform the one or more operations as discussed above.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computing device, or any other hardware equivalents, e.g., computer readable instructions pertaining to the method(s) discussed above can be used to configure a hardware processor to perform the steps, functions and/or operations of the above disclosed method(s). In one example, instructions and data for the present module or process 405 for protecting a sensor device (e.g., a software program comprising computer-executable instructions) can be loaded into memory 404 and executed by hardware processor element 402 to implement the steps, functions or operations as discussed above in connection with the example method(s). Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 405 for protecting a sensor device (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various embodiments have been described above, it should be understood that they have been presented by way of example only, and not limitation. Thus, the breadth and scope of a preferred embodiment should not be limited by any of the above-described example embodiments, but should be defined only in accordance with the following claims and their equivalents.

What is claimed is:

1. A method comprising:
monitoring, by a processing system including at least one processor of a first sensor device, a performance of at least one sensor function of the first sensor device;
detecting, by the processing system, an anomaly in the performance of the at least one sensor function;
sending, by the processing system, a request to at least one neighboring sensor device to host the at least one sensor function of the first sensor device;
receiving, by the processing system, an acceptance to the request from the at least one neighboring sensor device to host the at least one sensor function of the first sensor device; and
transferring, by the processing system, a software code of the at least one sensor function to the at least one neighboring sensor device.

2. The method of claim 1, further comprising:
transmitting, by the processing system, a report that the at least one sensor function of the first sensor device has been transferred to the at least one neighboring sensor device.

3. The method of claim 2, wherein the report is sent to a remote application server.

4. The method of claim 2, wherein the report is sent to a user endpoint device of a user.

5. The method of claim 2, wherein the report comprises at least one of: an identification of the first sensor device, a physical location of the first sensor device, an identification of the at least one neighboring sensor device, a physical location of the at least one neighboring sensor device, a time of the transferring of the software code, at least one step taken prior to the transferring, or a nature of the anomaly.

6. The method of claim 5, wherein the at least one step taken prior to the transferring comprises a resetting of the first sensor device.

7. The method of claim 5, wherein the at least one step taken prior to the transferring comprises an execution of a diagnostic test.

8. The method of claim 1, further comprising:
resetting, by the processing system, the first sensor device prior to the transferring.

9. The method of claim 1, further comprising:
executing, by the processing system, a diagnostic test prior to the transferring.

10. The method of claim 1, wherein the at least one sensor function comprises a first sensor function and a second sensor function, wherein the at least one neighboring sensor device comprises a first neighboring sensor device and a second neighboring sensor device, and wherein the first sensor function is transferred to the first neighboring sensor device and the second sensor function is transferred to the second neighboring sensor device.

11. The method of claim 1, further comprising:
verifying, by the processing system, that the at least one neighboring sensor device is on an approved list prior to the transferring.

12. The method of claim 1, wherein the first sensor device has a higher priority ranking relative to the least one neighboring sensor device.

13. The method of claim 1, wherein the request comprises at least one of: an identity of first sensor device, a description of the at least one sensor function, a hardware requirement necessary to support the at least one sensor function, a software requirement necessary to support the at least one sensor function, or a priority ranking of the first sensor device.

14. The method of claim 1, wherein the first sensor device or the least one neighboring sensor device comprises an internet of things device.

15. The method of 1, wherein the transferring further comprises transferring, by the processing system, a software code of a sensor device managing module of the first sensor device to the at least one neighboring sensor device.

16. The method of claim 1, wherein the first sensor device initiates a communication directly with the least one neighboring sensor device to negotiate the transferring.

17. The method of claim 16, wherein the communication is over a dedicated communication channel used solely for the transferring.

18. The method of claim 1, wherein the software code is encrypted or compressed.

19. A non-transitory computer-readable medium storing instructions which, when executed by a processing system including at least one processor of a first sensor device, cause the processing system to perform operations, the operations comprising:
monitoring a performance of at least one sensor function of the first sensor device;
detecting an anomaly in the performance of the at least one sensor function;
sending a request to at least one neighboring sensor device to host the at least one sensor function of the first sensor device;
receiving an acceptance to the request from the at least one neighboring sensor device to host the at least one sensor function of the first sensor device; and
transferring a software code of the at least one sensor function to the at least one neighboring sensor device.

20. An apparatus comprising:
a processing system including at least one processor of a first sensor device; and
a computer-readable medium storing instructions which, when executed by the processing system, cause the processing system to perform operations, the operations comprising:
monitoring a performance of at least one sensor function of the first sensor device;
detecting an anomaly in the performance of the at least one sensor function;
sending a request to at least one neighboring sensor device to host the at least one sensor function of the first sensor device;
receiving an acceptance to the request from the at least one neighboring sensor device to host the at least one sensor function of the first sensor device; and
transferring a software code of the at least one sensor function to the at least one neighboring sensor device.
